(19) United States
(12) Patent Application Publication
(10) Pub. No.: US 2002/0050460 A1
(43) Pub. Date: May 2, 2002

(54) Method and apparatus for calibrating a pH meter

(76) Inventors: Alfred J. LaGreca, Hingham, MA (US); David E. Butz, Groton, MA (US)

Correspondence Address: CESARI AND MCKENNA, LLP, 88 BLACK FALCON AVENUE, BOSTON, MA, 02210, US

(21) Appl. No.: 09/875,752

(22) Filed: Jun. 6, 2001

Related U.S. Application Data
(63) Continuation of application No. 09/262,416, filed on Mar. 4, 1999, now abandoned.

(51) Int. Cl. G01N 27/403

(52) U.S. Cl. 205/787.5; 204/406

(57) ABSTRACT

Apparatus for calibrating a pH meter includes a solution chamber for receiving a pH electrode so that a seal is established between the electrode and the wall of the chamber near the top of the chamber. A plurality of inlets are provided into the chamber so that air, a washing solution and a plurality of buffer solutions may be introduced into the chamber below the sealing means, the introduction of these fluids being controlled by valves. The chamber also has a fluid outlet at the bottom of the chamber controlled by a valve. All of the valves are actuated by a programmable controller which also receives a signal from a sensor which senses when the chamber is full of liquid. The controller controls the valves in a pre-determined sequence to pre-clean and fill the chamber with a washing solution, soak the electrode in the chamber for a pre-determined time and then drain the chamber of washing solution. Then, the controller controls the valves to pre-clean and fill the chamber with a buffer solution and soak the electrode in that solution for a sufficient time to enable an associated pH meter to obtain a stable reading of the pH is value of the buffer solution. After a stable reading is obtained, the controller may control the valves to empty the chamber and may refill the chamber with at least one additional buffer solution so that an additional measurement may be taken by the meter for that solution. After the final buffer solution has been emptied from the chamber, the controller may control the valves to introduce into the chamber a specimen solution whose pH value is to be determined.

### RELATED APPLICATION

This application is a continuation of Ser. No. 09/262,416, filed Mar. 4, 1999.

This invention relates to pH meters. It relates more particularly to a method and apparatus for calibrating a pH meter.

### BACKGROUND OF THE INVENTION

A pH meter is an instrument for measuring the pH value of a solution in order to determine the hydrogen-ion concentration of that solution on a scale of 0 to 14. A typical pH meter includes an electrode or probe in the form of a small sealed tube filled with a reference fluid. A conductor extends into one end of the tube and contacts the fluid, a second contact or conductor on the outside of the tube is grounded, both conductors being connected to a pH meter. In use, the probe is emersed in a specimen solution whose pH is to be measured. Due to the different characteristics of the fluids inside and outside the probe, a voltage is produced which is applied to the pH meter which thereupon determines the pH value of the specimen solution and then displays that value.

Before measuring the pH of a specimen solution, it is common practice to calibrate the meter and the meter's pH probe using standard solutions with known pH values. Currently, the industry uses three standard calibration solutions with pH values of 4.00, 7.00 and 10.00. Invariably all pH meters and probes are calibrated each time they are used and the user usually performs the calibration with one or two of the above three standard solutions, the particular solutions depending on the estimated pH value of the unknown solution or sample. This is usually referred to as a one or two point calibration. For example, assuming the user wants to calibrate the pH meter using the two-point method (using the pH 4 and 7 standards, for example) the user carries out the following steps:

Clean the pH probe with deionized water and dry the probe;

Place one of the two standard buffer solutions, usually the one with the lower pH value, i.e., pH 4.00, in a clean vial and immerse the electrode in that solution;

After a stable pH reading is obtained, set the pH meter to the value of that standard solution, i.e., pH=4.00, as the reported value regardless of the actual meter reading;

Clean and dry the electrodes as described in step 1;

Repeat steps two and three using the second standard solution, i.e. pH−7.00;

Repeat cleaning step to have the electrode ready for measuring the pH value of the specimen solution.

The procedure for a one point calibration is similar to the above except only one standard solution, e.g., pH−4.00, is used.

It is apparent that the above manual procedure requires the use of several different clean vials or the repeated re-washing of the same vial and repeated cleaning of the pH electrode prior to taking each reading, which is tedious and time consuming.

### SUMMARY OF THE INVENTION

Accordingly, it is an object of the present invention to provide a method for automatically calibrating a pH meter before the meter is used to measure the pH value of a given solution.

Another object of the invention is to provide such a method which is relatively easy to implement.

Yet another object of the invention is to provide an automatic pH meter calibration method which can be performed quickly and easily by relatively unskilled personnel.

A further object of the invention is to provide apparatus for automatically calibrating a pH meter having one or more of the above advantages.

The invention accordingly comprises several steps and the relation of one or more of said steps with respect to each of the others, and the apparatus embodying the features of construction, combination of elements and arrangement of parts which are adapted to effect such steps, all as exemplified in the following detailed description, and the scope of the invention will be indicated in the claims.

Briefly, in accordance with our method, a washing solution and the various standard buffers and usually, but not necessarily, the specimen whose pH is being measured are routed in a predetermined sequence to a special solution chamber adapted to contain the electrode of the pH meter being calibrated. Two groups of valves are used to control the type and flow direction of the various solutions to and from the solution chamber. A programmable controller interfaced with the pH meter controls the various valves to perform the automatic pH meter calibration described in detail hereinafter.

### BRIEF DESCRIPTION OF THE DRAWINGS

For a fuller understanding of the nature and objects of the invention, reference should be had to the following detailed description taken in connection with the accompanying drawings, in which:

FIG. 1 is a schematic diagram of apparatus for automatically calibrating a pH meter;

FIG. 2 is a diagram illustrating the operation of the FIG. 1 apparatus, and

FIG. 3 is a view similar to FIG. 1 of another pH meter calibration apparatus.

### DETAILED DESCRIPTION OF THE PREFERRED EMBODIMENTS

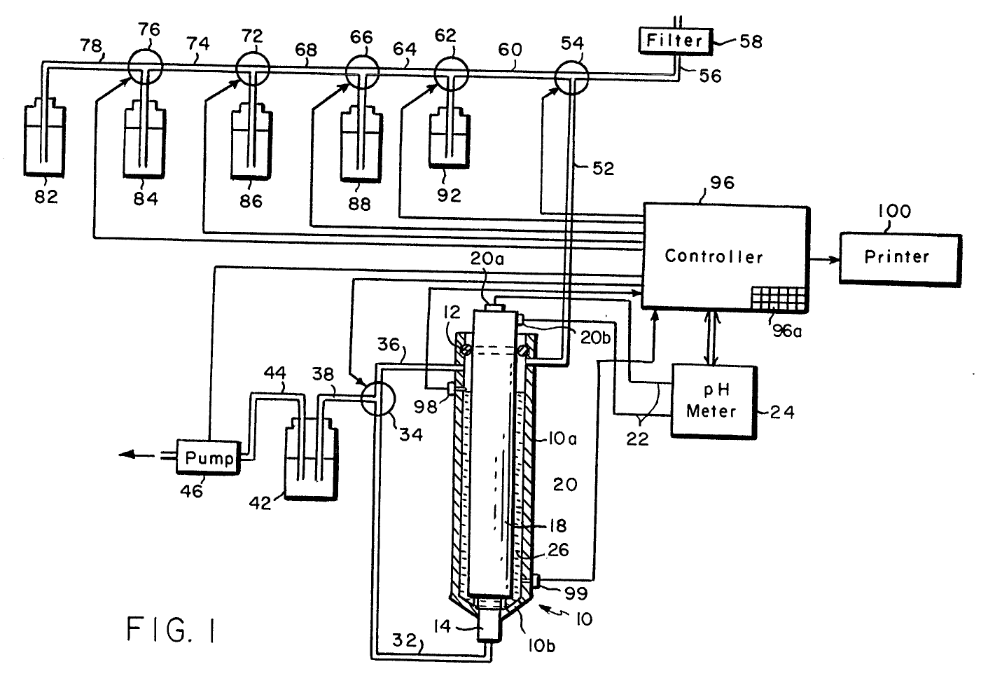

Referring to FIG. 1 of the drawings, the automatic pH calibration apparatus comprises an open top solution chamber 10 having a generally cylindrical sidewall 10a and a bottom wall 10b. Sidewall 10a has an internal groove near the top of chamber for accepting an O-ring 12, and bottom wall 10b is provided with a drain outlet 14.

Chamber 10 is adapted to receive and support in an upright position a more or less conventional pH electrode 18. The electrode is basically a closed, thin-wall glass tube or vial 20 about ⅜ inch in diameter filled with a reference liquid having a selected pH value. The electrode includes an inner contact 20a which contacts the liquid in the tube and an outer ground contact 20b at the top of the electrode, both contacts being connected by wires 22 to a pH meter 24. When the chamber 10 is filled with a liquid as indicated at 26, an electrical potential is developed across the electrode contacts 20a and 20b which reflects the difference in the pH values of the liquids inside and outside the electrode 18. That voltage signal is applied to the pH meter 24 which thereupon produces an output indication on an indicator or display 24a of the pH value of the liquid 26 in chamber 10. The operation of such pH meters is well known and therefore will not be described in more detail here.

The chamber drain outlet 14 is connected by a conduit 32 to one arm of a three-way valve 34, the other arm of which is connected by a conduit 36 which leads to the interior of chamber 10 near the top thereof below O-ring 12. The leg of valve 34 is connected by a conduit 38 to a sealed waste container or sump 42. A second conduit 44 leads from the container 42 to a vacuum pump 46.

Various fluids may be introduced into chamber 10 through a conduit 52 leading from a valve 54 to a location in chamber side wall 10a near the top of the chamber below O-ring 12. Valve 54 is a three-way valve having one arm connected to a conduit 56 vented to the atmosphere through a filter 58. The other arm of valve 54 is connected to the arms of a series of similar 3-way valves. More particularly, valve 54 is connected via a conduit 60 to a valve 62 which is connected by way of a conduit 64 to a valve 66. That valve leads, in turn, via conduit 68 to another valve 72 which is connected by a conduit 74 to one arm of a valve 76, the other arm of which is connected by conduit 78 to a container 82. The leg of valve 76 is connected to a similar container 84, while the leg of valve 72 is connected to a container 86. The leg of valve 66 is connected to another container 88 and finally the leg of valve 62 is connected to a container 92. Containers 82, 84 and 86 are designed to contain different standard buffer solutions, e.g., pH 4, pH 7 and pH10, respectively. Container 88 normally contains a washing solution such as deionized water, while container 92 is filled with a specimen solution whose pH is to be determined. All of the aforesaid containers are self-venting or collapsible so that the container contents can be withdrawn from those containers by way of the valves connected thereto.

All of the valves described above are preferably solenoid valves whose internal valve elements are biased so that the two arms of each valve are in fluid communication while the leg of that valve is blocked. A suitable three-way valve for use in a closed fluid system of this general type is described in our pending application Ser. No. 09/262,416, filed Mar. 1, 1999, entitled Two-Piece Solenoid Valve, the contents of which is hereby incorporated herein by reference.

Pump 46 as well as all of the valves 34, 54, 62, 66, 72 and 76 are controlled by signals from a programmable controller 96 having a keypad 96a so as to introduce various fluids into and drain them from chamber 10 in order to practice the invention. Preferably, a conventional liquid level sensor 98 is installed in the wall 10a of chamber 10 below O-ring 12 to sense when chamber 10 is filled with a liquid 26, the sensor providing a full signal to controller 96 when that event occurs. A second sensor 99 may also be provided to tell the controller by an empty signal when the chamber 10 is empty of liquid. Preferably also, the controller 96 controls the operation of a printer 100 capable of printing the pH values and other data for the various liquids 26 introduced into chamber 10.

In order to use the present apparatus, the electrode 18 of pH meter 24 is inserted into chamber 10 as shown so that the electrode along with the O-ring 12 seals the open top of the chamber.

To start the calibration procedure, the operator may press a start button on keyboard 96a. At start, controller 96 is programmed to go through a wash cycle as follows:

| | |
|---|---|
| A. WASH | Controller 96 controls as follows: |
| Step 1 Pre-clean and | valve 34 opens 32 to 38 and blocks 36 |
| Fill | valve 54 opens 56 and blocks 60 |
| | valve 62 opens 64 and blocks 92 |
| | valve 66 opens 88 and blocks 68 |
| | pump 46 on so wash liquid 88 flows through |
| | chamber 10 to sump 42; |
| | after, e.g., 10 seconds, controller switches |
| | valve 34 so valve opens 36 and closes 32 whereby |
| | chamber 10 is vented and fills with water; |
| | controller 96 turns off pump 46 when sensor 98 |
| | detects that chamber is filled and allows electrode |
| | to soak in chamber for cleaning purposes; any |
| | overflow may flow out through 36 to sump 42. |
| Step 2 Soak | valve 34 blocks drain 14 for selected time, e.g., |
| | 10 seconds. |
| Step 3 Empty | valve 54 opens 56 and closes 60 |
| | valve 34 opens 32 and closes 36 |
| | so liquid in chamber is drained into container 42; |
| | after selected time, e.g., 15 sec., or when sensor |
| | 99 signals chamber empty, pump 46 turned off. |

Repeat Steps 1-3 (optional)

| | |
|---|---|
| B. MEASURE pH 4 | Controller 96 controls as follows: |
| SOLUTION | |
| Step 4-Preclean and | valve 34 opens 32 and closes 36 |
| Fill | valve 54 opens 60 and closes 56 |
| | valves 62, 66, 72 and 76 open to respective arms; |
| | pump 46 on so pH 4 buffer drawn from container |
| | 82 through chamber 10 into container 42 thus |
| | bathing probe 18 in pH 4 solution. After selected |
| | time, e.g., 10 sec, valve 34 switched to close |
| | 32 and open 36 so chamber 10 fills with |
| | pH 4 solution. The pump 46 is turned off |
| | when sensor 98 signals controller that |
| | chamber is filled. |
| Step 5-Soak | electrode remains soaking in chamber 10 |
| | for selected time sufficient to allow meter |
| | 24 to obtain stable reading of pH value of buffer |
| | solution in chamber |
| Step 6-Measure | controller controls meter 24 to the take pH |
| | reading of solution and sets meter to pH 4 |
| | regardless of actual reading and that measurement |
| | is recorded in pH meter's memory |
| Step 7-Empty | valve 54 opens 56 and closes 60 |
| | valve 34 opens 32 and closes 36 |
| | pump 46 on so pH 4 solution drains from |
| | chamber 10 into container 42. |

Washing between measurements (optional)
Repeat Steps 1 to 3
C. MEASURE pH 7
SOLUTION
Same as Steps 4-7 except that valve 76 opens to container 84 so that
pH 7 solution is drawn into chamber 10.
D. FINAL WASHING
Repeat steps 1-3
pH electrode 18 and meter 24 are now ready for use

After the FINAL WASHING D, the controller 96 causes the printer 100 to print out final calibration data such as date and time, each buffer's measured pH, calculated slope and coefficient, as well as intercept. It also print out a final result, i.e., calibration successful or not. If the calibration is unsuccessful, the above-described procedure must be repeated. If calibration is successful, the system is ready to carry out a measurement on an unknown sample. For this, steps, 4 to 7 are repeated except valve 62 opens to container 92 so that specimen solution is drawn into chamber 10.

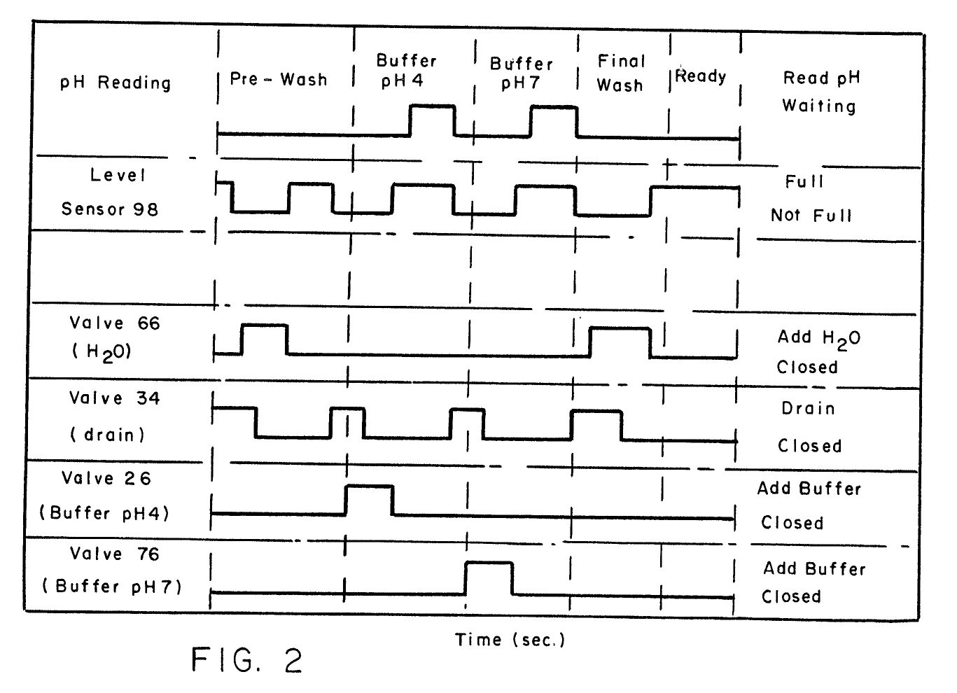

FIG. 2 shows the sequence of events in performing a two-point pH4/7 calibration as above. In this diagram, the optional repeated pre-cleaning and washing between measurements steps are not performed.

Of course, if a one point calibration were being carried out on the specimen in chamber 10, only a single buffer, say the pH 4 solution, would be drawn into that chamber during the calibration procedure. Also, if the estimated pH value of the specimen solution were estimated to be higher than pH 7, then a two-point calibration using the pH 7 and pH 10 buffers would be used, with controller 96 being programmed to operate valves 76 and 72 to draw the buffers from containers 86 and 84, respectively, at the appropriate times in the calibration cycle.

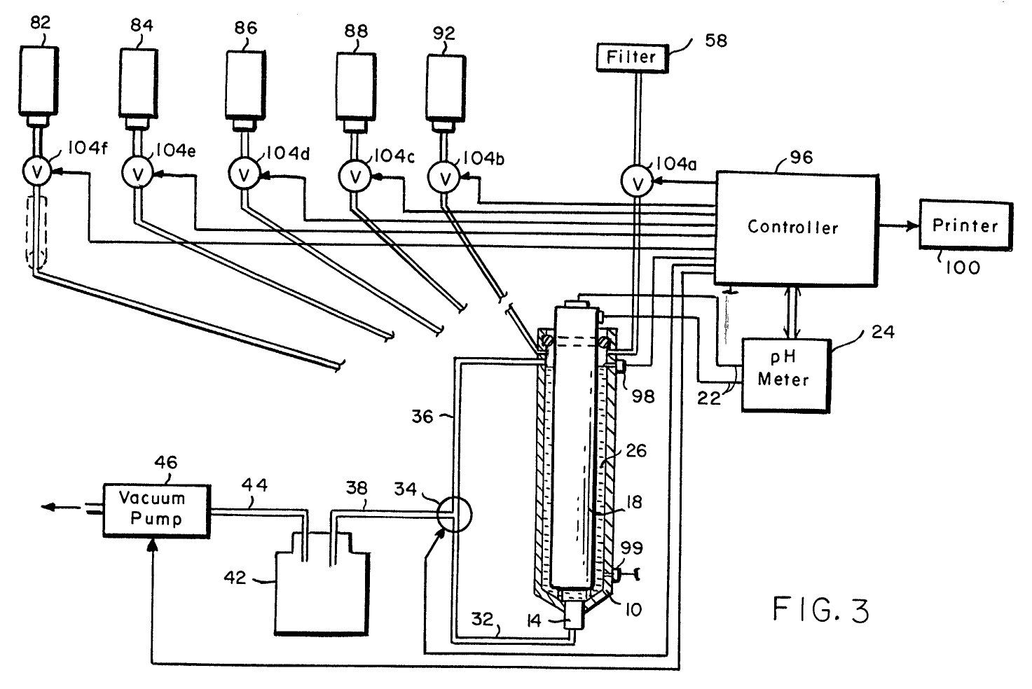

Various valving arrangements may be used to conduct liquids to and drain them from the solution chamber 10. FIG. 3 shows an arrangement utilizing two-way solenoid valves of the type disclosed in the above-identified pending application. The FIG. 3 apparatus is more or less the same as the one shown in FIG. 1 except that the conduits leading from the various containers are connected to chamber 10 around the periphery of the container sidewall 10a (FIG. 1) near the top of that wall below O-ring 12 (FIG. 1). The flows of fluids through the various conduits are controlled by individual two-way valves 104a to 104f. Controller 96 controls those valves and the three-way valve 34 and pump 46 so as to carry out the pre-clean, soak, empty, measure and final wash functions described above.

In some applications, the solution containers may be positioned a sufficient distance above chamber 10 that the force of gravity may be used to deliver solutions to and drain them from chamber 10. In that event, the container 42 and vacuum pump 46 may be eliminated and the chamber 10 arranged to drain directly into a sink or a drain pipe. Also, since chamber 10 does not have to be fluid tight in this event, the O-ring 12 is not required.

Also, instead of relying on the open time of the valve in the conduit leading from each solution container in order to fill chamber 10, the conduit leading from each solution container, e.g., container 82, may contain a volume metering chamber as shown in phantom at 108 at the left side of FIG. 3. A valve 104f leading from that container 82 may be opened at the appropriate time in the calibration sequence to fill chamber 108. Then a second valve 110 at the outlet of that chamber may be opened while valve 104f is closed so that a specific volume of liquid corresponding to the volume of liquid required to fill chamber 10 is delivered to that chamber. In that event, the liquid level sensor 98 may be omitted.

It will thus be seen that the objects set forth above, among those made apparent from the preceding description, are efficiently attained. It will also be understood that certain changes be made in carrying out the above method and to the above constructions without departing from the scope of the invention. For example, the same apparatus may also be used for calibrating other instruments such as meters for measuring ionic conductivity. Therefore, it is intended that all matter contained in the above description or shown in the accompanying drawings, shall be interpreted as illustrative and not in a limiting sense.

It is also to be understood that the following claims are intended to cover all of the generic and specific features of the invention described herein.

What is claimed is:

1. Apparatus for calibrating a pH meter of the type having a pH electrode which produces an output signal indicative of pH and an indicator responsive to said output signal for indicating pH, said apparatus including
a solution chamber having a top opening for receiving the pH electrode of a pH meter being calibrated;
a controllable wash solution source connected to said chamber for conducting a wash liquid into the chamber;
a controllable first buffer source connected to said chamber through a second valve for conducting a first buffer solution a first pH into said chamber;
a drain line leading from said chamber through a controllable drain valve, and
control means responsive to said output signal and programmed to control said sources and said drain valve so that sequentially
the chamber is flushed and filled with wash liquid fed thereto from said wash source so as to soak an electrode received in the chamber,
after a selected time, the wash liquid is drained from said chamber via said drain valve,
the chamber is flushed and filled with the first buffer solution fed thereto from the first buffer source, and
while the chamber is filled with first buffer solution, the control means issues a first control signal for the pH meter being calibrated to sample the output signal from the electrode received in said chamber to produce a first sampled signal value and to set said indicator to indicate the first pH when said electrode produces said first sampled signal value.

2. The apparatus defined in claim 1
further including a controllable second buffer source connected to said chamber for conducting a second buffer solution having a second pH different from the first pH into the chamber, and
wherein the control means is programmed to control said sources and said drain valve after issuance of the first control signal so that sequentially
the first buffer solution is drained from the chamber via said drain valve,
the chamber is flushed and filled with wash liquid fed thereto from said wash source so as to soak the electrode received in the chamber,
after a selected time, the wash liquid is drained from the chamber via said drain valve,
the chamber is flushed and filled with second buffer solution fed thereto from the second buffer source, and
while the chamber is filled with the second buffer solution, the control means issues a second control signal for the pH meter being calibrated to sample the output signal from the electrode received in said chamber to produce a second sampled signal value and to set said indicator to indicate the second pH when the electrode produces the second sample signal value.

3. The apparatus defined in claim 2
further including a controllable sample source connected to said chamber for conducting a sample solution having an unknown pH into said chamber, and
wherein the control means is programmed to control said sources and said drain valve after issuance of the second control signal so that sequentially
the second buffer solution is drained from the chamber via said drain valve,
the chamber is flushed and filled with the sample solution so as to bathe the electrode received in said chamber, and
while the chamber is filled with the sample solution, the control means issues a third control signal directing the pH meter being calibrated to sample the output signal from the electrode received in said chamber to produce a third sampled signal value which causes said indicator to indicate the pH of the sample solution.

4. The apparatus defined in any one of claims 1 to 3 wherein said valves are solenoid valves.

5. The apparatus defined in any one of claim 1
wherein said drain valve is a three-way-valve having first and second arms and a leg, the first arm being connected to said drain line and the second arm communicating with said the interior of said chamber near the top opening therein, and
further including sealing means for sealing the top opening of the chamber when a pH electrode is received in said chamber, and a vent line including a vent valve connecting the interior of said chamber below said sealing means to the atmosphere, and
wherein the control means is programmed to open said vent valve only when a solution is entering or leaving said chamber.

6. The apparatus defined in claim 5 further including a sensor mounted to said chamber for detecting when said chamber is filled with liquid and sending a FULL signal to said control means in response thereto, and
wherein said control means is programmed to open said drain valve a selected time after receiving said FULL signal.

7. The apparatus defined in claim 5
and further including a first sensor mounted to said chamber for detecting when the chamber is filled with liquid and sending a FULL signal to said controller in response thereto and,
a second sensor mounted to said chamber for detecting when the chamber is empty of liquid and sending an EMPTY signal to the control means in response thereto, and
wherein the control means is programmed to stop the flow of liquid from said sources to said chamber upon receiving a FULL signal and to close the drain valve upon receiving an EMPTY signal.

8. The apparatus defined in any one of claim 1 further including a sensor mounted to said chamber for detecting when said chamber is filled with liquid and sending a FULL signal to said control means in response thereto, and
wherein said control means is programmed to open said drain valve a selected time after receiving said FULL signal.

9. The apparatus defined in any one of claim 1 and further including a first sensor mounted to said chamber for detecting when the chamber is filled with liquid and sending a FULL signal to said controller in response thereto and,
a second sensor mounted to said chamber for detecting when the chamber is empty of liquid and sending an EMPTY signal to the control means in response thereto, and
wherein the control means is programmed to stop the flow of liquid from said sources to said chamber upon receiving a FULL signal and to close the drain valve upon receiving an EMPTY signal.

10. The apparatus defined in claim 1 further including a controllable sample source connected to said chamber for conducting a sample solution having an unknown pH into said chamber, and
wherein the control means is programmed to control said sources and said drain valve after issuance of the second control signal so that sequentially
the second buffer solution is drained from the chamber via said drain valve,
the chamber is flushed and filled with the sample solution so as to bathe the electrode received in said chamber, and
while the chamber is filled with the sample solution, the control means issues a third control signal directing the pH meter being calibrated to sample the output signal from the electrode received in said chamber to produce a third sampled signal value which causes said indicator to indicate the pH of the sample solution.

11. A method for calibrating a pH meter of the type having a pH electrode which produces an output signal indicative of pH and an indicator responsive to said output signal for indicating pH, said method including the steps of
providing a solution chamber having a top opening for receiving the pH electrode of a pH meter being calibrated;
providing a controllable wash solution source connected to said chamber for conducting a wash liquid into the chamber;
providing a controllable first buffer source connected to said chamber through a second valve for conducting a first buffer solution a first pH into said chamber;
forming a drain line leading from said chamber through a controllable drain valve, and
in response to said output signal controlling said sources and said drain valve so that sequentially
the chamber is flushed and filled with wash liquid fed thereto from said wash source so as to soak an electrode received in the chamber,
after a selected time, the wash liquid is drained from said chamber via said drain valve,
the chamber is flushed and filled with the first buffer solution fed thereto from the first buffer source, and
while the chamber is filled with first buffer solution, the control means issues a first control signal for the pH meter being calibrated to sample the output signal from the electrode received in said chamber to produce a first sampled signal value and to set said indicator to indicate the first pH when said electrode produces said first sampled signal value.
